(19) United States
(12) Patent Application Publication
(10) Pub. No.: US 2006/0133221 A1
(43) Pub. Date: Jun. 22, 2006

(54) Method of managing playback speed information of a recording medium, recording medium with playback speed information for video content recorded thereon, and reproducing method for the recording medium

(75) Inventors: Sang Woon Suh, Seoul (KR); Jin Yong Kim, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 10/543,129

(22) PCT Filed: Jan. 20, 2004
(86) PCT No.: PCT/KR04/00108

§ 371 Date: Jan. 26, 2006

(30) Foreign Application Priority Data
Jan. 24, 2003 (KR) 10-2003-0004931

(51) Int. Cl. G11B 21/08

(52) U.S. Cl. 369/30.01; 369/47.1

(57) ABSTRACT

The present invention relates to a method of enabling to reproduce main AN data recorded on a high-density recording medium such as a Blu-ray Disc ROM at a playback speed suitable to the recorded main A/V data. In the present method, when main video data is recorded on a recording medium, playback speed information suitable to the video data is also written within a disc information table allocated in a control area that is located ahead of a data area including the video data. The present method is efficiently applicable to a high-density recording medium containing higher-quality video data that requires higher transfer rate than a digital TV broadcast stream that requires about 36 Mbps transfer rate.

### 1. TECHNICAL FIELD

The present invention relates to a method of managing playback speed information for reproducing a main A/V data recorded on a high-density recording medium such as a Blu-ray Disc ROM at a playback speed suitable to the recorded A/V data, and a high-density recording medium having such playback speed information.

The present invention relates to a method of reproducing a main A/V data recorded on a high-density recording medium at an appropriate playback speed based on information obtained from such a high-density recording medium.

2. BACKGROUND ART

The standardization of new high-density rewritable optical discs capable of recording large amounts of high-quality video and audio data has been progressing rapidly and new optical disc related products are expected to be commercially available on the market in the near future. The Blu-ray Disc Rewritable (BD-RE) is one example of these new optical discs.

As shown in FIG. 1, a BD-RE is organized, in the radial direction, into a clamping area, a transition area, and a burst cutting area (BCA), a lead-in area, a data area, and a lead-out area.

The lead-in area is organized into the first guard (Guard 1) area, a permanent information and control data (PIC: Permanent Information & Control data) area, the second guard (Guard 2) area, an information (Info 2) area, and an optimum power calibration (OPC) area. While, the Guard 1 area and the PIC area are pre-recorded areas, the others of the lead-in area, the data area, and the lead-out area are all rewritable areas.

The PIC area is used to write or store a disc general information that should be kept permanently. The disc general information is encoded through high-frequency modulation and is then written to the track wobble on the disc through bi-phase modulation, as shown in FIG. 2.

According to FIG. 2, HFM Grooves are modulated in the radial direction with a rather high bandwidth signal, to create a data channel for replicated information with sufficient capacity and data rate.

In this modulation method a bit with value 0 is represented by a transition at the start of the bit cell and a bit with value 1 is represented by a transition at the start and in the middle of the bit cell. The modulated bits are recorded on the disc by a deviation of the groove from its average centerline as indicated in the FIG. 2. The length of each bit cell shall be 36T, where T corresponds to the length of a channel bit in the Rewritable data areas.

In addition to the BD-RE, technical specifications on Blu-ray disc read-only (BD-ROM) have been discussed intensively among major companies. As shown in FIG. 3, a BD-ROM is organized into an inner area, a clamping area, a transition area, an information area, and a rim area. The BD-ROM is characterized in that a data zone within the information area is capable of storing high-quality A/V main data.

For example, the BD-RE is commonly used to write digital TV broadcast stream data, whose transfer rate is about 36 Mbps. On the other hand, the BD-ROM is capable of storing A/V stream data of high-quality video contents that requires higher transfer rate, say, 40 Mbps or more. Hence, if the transfer rate suitable to the high-quality A/V stream recorded on a BD-ROM is unknown, read-out operation of data from the BD-ROM at a transfer rate of 36 Mbps causes reproduction of the A/V stream to fail.

### 3. DISCLOSURE OF THE INVENTION

It is therefore a primary object of the present invention to provide a method of managing playback speed information recorded on a read-only recording medium that enables to reproduce a video content recorded thereon at a playback speed suitable to the video content.

It is another object of the present invention to provide a recording medium having playback speed information that specifies a playback speed at which real-time video contents recorded thereon can be reproduced successfully.

It is another object of the present invention to provide a method of obtaining a playback speed from a recording medium at which a video content on a recording medium can be reproduced and reproducing the recording medium at the playback speed.

A method of recording playback speed information on a recording medium in accordance with the present invention comprising: recording a video data on the recording medium; and recording playback speed information for the video data ahead of a data area where the video data is recorded.

A recording medium according to the present invention is characterized in that the recording medium includes video data as well as playback speed information thereof that is written ahead of a data area including the video data.

A method of reproducing a recording medium according to the present invention including the steps of: driving the recording medium on which the video data is recorded; obtaining playback speed information for the video data from the recording medium; and reproducing the video data while driving the recording medium at a speed equal to or faster than a speed specified by the playback speed information.

According to the present invention, it is possible to reproduce high-quality A/V contents on the recording medium that require higher transfer rate than a digital TV broadcast stream.

### 4. BRIEF DESCRIPTION OF THE DRAWINGS

In the drawings:

FIG. 1 shows a schematic diagram of a disc structure of a Blu-ray disc rewritable (BD-RE);

FIG. 2 shows high-frequency modulated grooves formed on a PIC area of a BD-RE;

FIG. 3 shows an area format of a read-only blue-ray disc (BD-ROM);

FIG. 4 illustrates a lead-in zone on which playback speed information is recorded according to the present invention;

FIG. 5 shows a disc information table on a PIC area including playback speed information according to the present invention; and

FIG. 6 shows a schematic diagram of an optical disc reproducing apparatus for reproducing a high-density blue-ray disc according to the present invention.

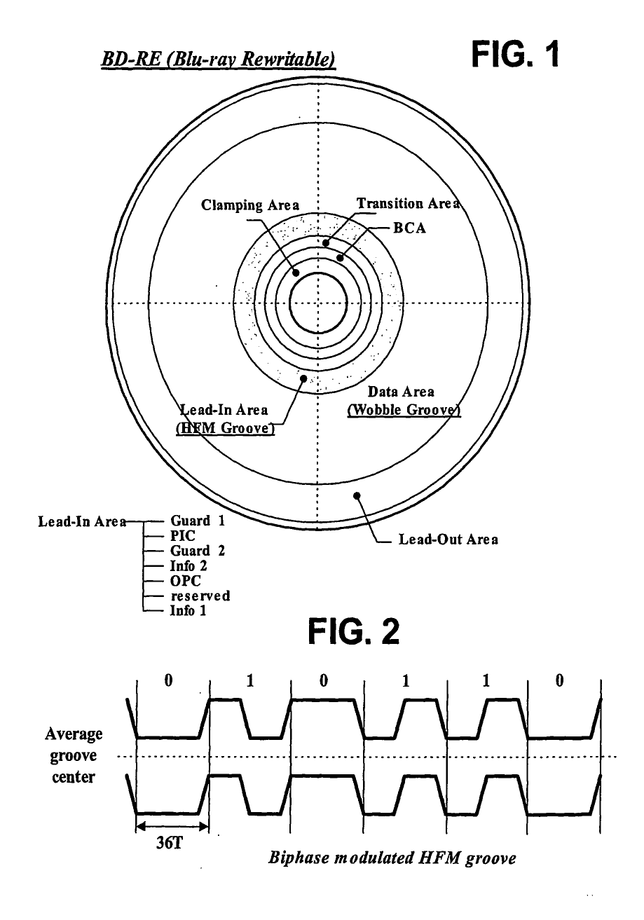

### 5. BEST MODE FOR CARRYING OUT THE INVENTION

In order that the present invention may be fully understood, preferred embodiments thereof will now be described with reference to the accompanying drawings.

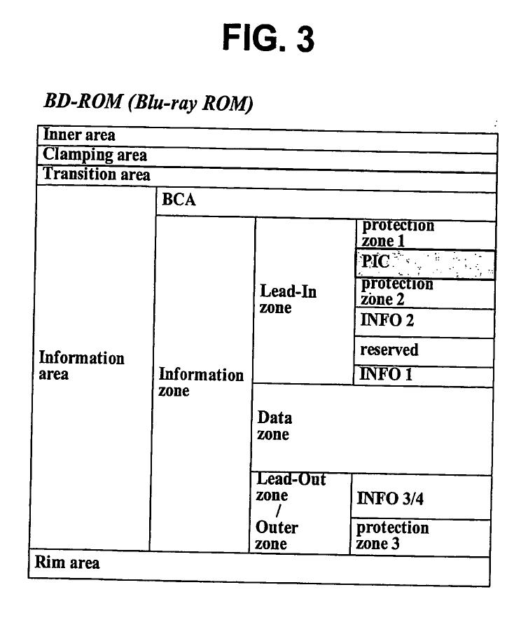

As described before with reference to FIG. 3, a BD-ROM according to the present invention is organized into an inner area, a clamping area, a transition area, an information area, and a rim area.

Disc information includes, among other things, disc information (DI) identifier, DI format, and disc size/version, and is recorded in a permanent information and control data (PIC) area in the information area. Data is recorded on the BD-ROM by making pre-pits on the surface of the BD-ROM.

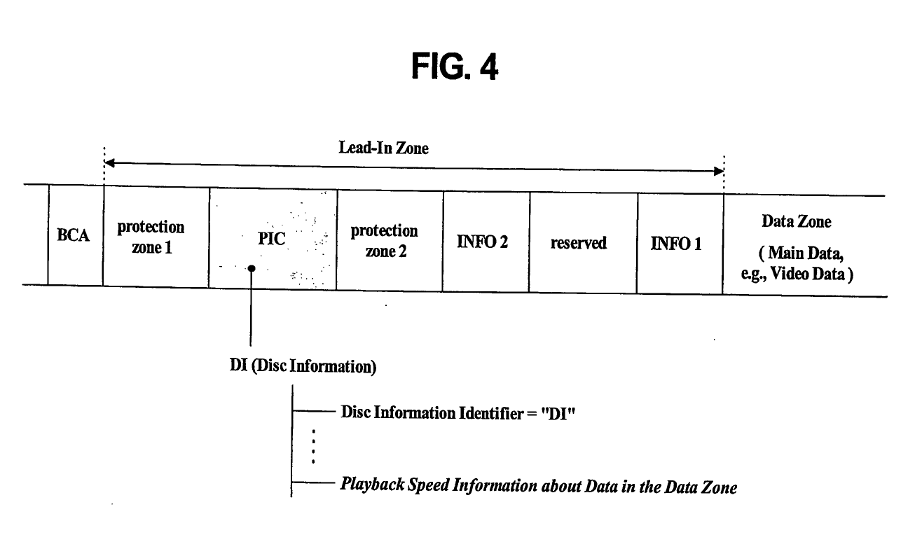

A data zone in the information area is used to write real-time high-quality video data such as movie contents that requires a transfer rate of 40 Mbps or more. As shown in FIG. 4, the disc information includes, besides general information including a disc information identifier, playback speed information of the video data.

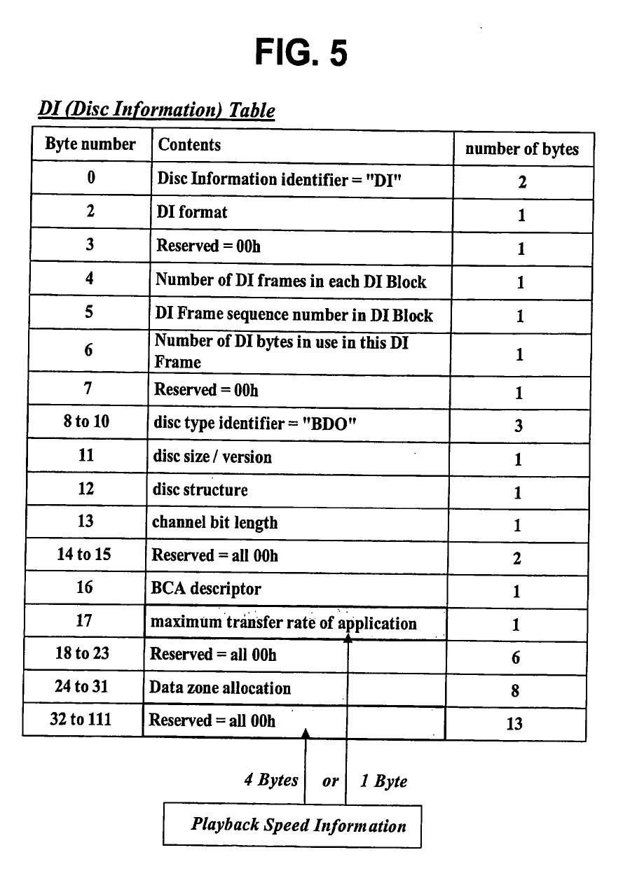

For example, FIG. 5 illustrates DI(Disc Information), which includes “the disc information identifier” representing the characters “DI” at zero byte, “DI format” identifying the contents of the DI unit at 2^{nd} byte, “Number of DI frames in each DI block” specifying the number of DI units N in each DI Block (1<N<32) at 4^{th} byte, “DI unit sequence number in DI block” specifying the sequential DI unit number within the DI block at 5^{th} byte, “Number of DI bytes in use in this DI unit” indicating the number of bytes in use in the actual DI unit at 6^{th} byte, “Disc type identifier” representing the characters “BDO” at 8^{th} to 10^{th} bytes, “Disc size/version” specifying the disc size and disc version number at 11^{th} byte, “disc structure” specifying the number of recorded layers and the type of the recoded layers at 12^{th} byte, “channel bit length” specifying the main data channel bit length at 13^{th} byte, “BCA descriptor” indicating the presence of a BCA-code on this disc at 16^{th} byte, “maximum transfer rate of application” specifying the maximum transfer rate needed by the application and represented by Mbit/s, and “data zone allocation” specifying the first and the last address unit numbers of the data zone of the related layer. In addition to that, according to this invention, the playback speed information is four bytes long and is recorded in a reserved area within the disc information table, at the 32-th to 35-th bytes, as shown in FIG. 5. The playback speed information also may be recorded with “maximum transfer rate information” recorded in the field of ‘maximum transfer rate of application’ that is one byte long.

Meanwhile, the playback speed information may be recorded as a ratio thereof to a transfer rate of digital TV broadcast stream of 36 Mbps (hereinafter this transfer rate is denoted by 1×). For example, if the transfer rate of a video content from the BD-ROM is higher than 40 Mbps, and the ratio is equal to k, where k is an integer equal to or greater than 1, the playback speed information becomes greater than 40/36×k (approximately 1.12 k). If the transfer rate of the video content is 40 Mpbs, then 1.12 k is recorded as the playback speed information.

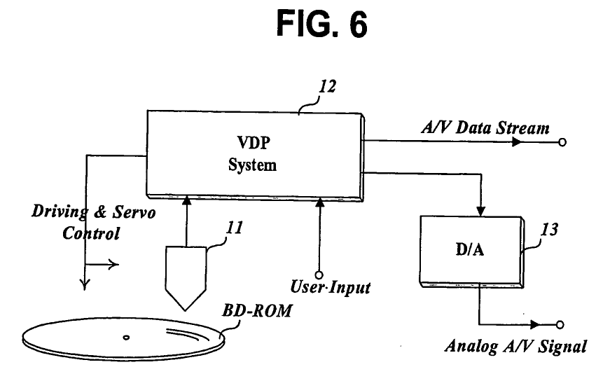

As shown in a schematic diagram of FIG. 6, an optical disc reproducing apparatus according to the present invention includes, among other things, an optical pickup 11 for picking up signals from am optical disc; a video disc play (VDP) system 12 for performing signal processing and servo-control operations; and a D/A converter 13.

Once a BD-ROM is loaded on which a video content has been recorded together with playback speed information thereof, the VDP system 12 starts to rotate the BD-ROM and then controls the optical pickup 11 so as to locate the PIC area on the BD-ROM and to read the disc information from the PIC area. At the time of initial reproduction, the BD-ROM is reproduced at a basic speed of 1× or an allowable maximum speed at which data can be read out from the PIC area. If it is determined that data on the PIC area is encrypted, the BD-ROM should be rotated at the allowable maximum speed.

Then, the playback speed information is obtained from one byte at the 17-th byte or four bytes at the 32-th byte of the disc information.

For example, if transfer rate information is identified as 40 Mbps, that is, 1.12 k, the VDP system 12 drives the BD-ROM at a speed of 1.12 k times 1× (hereinafter is denoted by 1.12 kX) or more than 1.12 kX, for example 1.5 kX, and moves the optical pickup 11 to the data zone so that video and/or audio data is read out and then decoded into the output. The transfer rate information indicating 40 Mbps may be recorded as one byte long in the field of “maximum transfer rate of application”. If the optical disc reproducing apparatus of FIG. 6 can operate at multiple playback speed levels, e.g., N₁X, N₂X, N₃X, . . . , N_{I}X, where N₁, N₂, N₃, . . . , N_{I} are all integers, and if none of the multiple playback speed levels are equal to the transfer rate, the video content is reproduced at one of multiple playback speed levels that is the closest one faster than the transfer rate. For example, if the playback speed is 1.12 k, which falls between N_{I-2} and N_{I-1} (N_{I-2}<N_{I-1}), the VDP system 12 drives the BD-ROM at a speed of N_{I-1}X.

While the invention has been disclosed with respect to a limited number of embodiments, those skilled in the art, having the benefit of this disclosure, will appreciated numerous modifications and variations therefrom. It is intended that all such modifications and variations fall within the spirit and scope of the invention.

1. A method of recording data on a recording medium, comprising:
recording a main data on the recording medium; and
recording playback speed information for the main data in a control area followed by a data area where the main data is recorded.

2. The method as set forth in claim 1, wherein the control area is lead-in area, the playback speed information is recorded within a control information table allocated in the lead-in area on the recording medium.

3. The method as set forth in claim 2, further comprising:
recording maximum transfer rate information in the control information table, wherein the maximum transfer rate information specifies the maximum transfer rate needed by an application.

4. The method as set forth in claim 21, wherein the playback speed information represents 1.2 or 1.5 times of reference speed.

5. The method as set forth in claim 1, wherein the playback speed information is determined such that the main data on the recording medium is reproduced at a 1.2 or 1.5 times of reference speed.

6. The method as set forth in claim 1, wherein the playback speed information is determined such that the main data on the recording medium is reproduced at a transfer rate of 36 Mbps 40 Mbps or faster.

7. The method as set forth in claim 1, wherein the playback speed information is recorded as a ratio of transfer rate of the main data to a standard transfer rate of a digital television broadcast stream.

8. A recording medium, comprising:
a data area storing main data recorded thereon; and
playback speed information associated with a playback speed of the main data, wherein the playback speed information is recorded in a control area followed by the data area.

9. The recording medium as set forth in claim 8, wherein the playback speed information is recorded within a control information table allocated in the control area on the recording medium.

10. The recording medium as set forth in claim 9, further comprising:
maximum transfer rate information specifying the maximum transfer rate required by application.

11. The recording medium as set forth in claim 9, wherein the playback speed information represents 1.2 or 1.5 times of reference speed.

12. The recording medium as set forth in claim 8, wherein the playback speed information is determined such that the main data on the recording medium is reproduced at a transfer rate that is equal to or faster than a standard transfer rate of a digital television broadcast stream.

13. The recording medium as set forth in claim 8, wherein the playback speed information is recorded as a ratio of transfer rate of the main data to a standard transfer rate of a digital television broadcast stream.

14. A method of reproducing a data recorded on a recording medium, comprising the steps of:
driving the recording medium on which the main data is recorded;
obtaining playback speed information for the main data from the recording medium; and
reproducing the main data by referring to the playback speed information.

15. The method as set forth in claim 14, wherein the driving step drives the recording medium at a predetermined basic speed of the recording medium.

16. The method as set forth in claim 14, wherein the driving step drives the recording medium for a data area at a maximum speed at which a reproducing apparatus can read out data from the data area.

17. The method as set forth in claim 14, wherein the playback speed information is obtained from a control information allocated in a control area on the recording medium.

18. The method as set forth in claim 14, wherein the driving step, drives the recording medium such that the main data is read out at a transfer rate that is equal to or faster than a standard transfer rate of digital television broadcast stream.

19. The method as set forth in claim 14, wherein, in the reproducing step, if it is determined that the recording medium can not be driven exactly at a speed specified by the playback speed information, and if a disc reproducing apparatus supports multiple playback speed levels, the main data is reproduced at a speed that is the closest one faster than the specified speed among the multiple playback speed levels.

20. The method as set forth in claim 14, wherein the reproducing step drives the recording medium at a speed equal to or faster than a speed specified by the playback speed information.

21. The method as set forth in claim 14, further comprising:
obtaining maximum transfer rate information for the main data from the recording medium; and
reproducing the main data by referring to the playback speed information and the maximum transfer rate information.

22. A method of recording data on a recording medium, comprising the steps of.
recording a control information on a specific area of the recording medium, the control information including a playback speed information and a maximum transfer rate information specifying the maximum transfer rate needed by an application, wherein the playback speed information is distinguished from the maximum transfer rate information; and
recording main data on a main data area.

23. The method of claim 22, wherein the specific area is lead-in area, the playback speed information and the maximum transfer rate information are recorded within a control information table allocated in the lead-in area on the recording medium.

24. The method of claim 23, wherein the control information table further includes a recording medium size and version information specifying the medium size and version number respectively, a medium structure information specifying the number of recorded layers and the type of the recoded layers, and a recording density information associated with recording density of the recording medium.

25. The method of claim 22, wherein the playback speed information represents 1.2 or 1.5 times of reference speed.

26. The method of claim 22, wherein the playback speed information is determined such that the main data on the recording medium is reproduced at 1.2 or 1.5 times of reference speed.

27. The method of claim 22, wherein the playback speed information is determined such that the main data on the recording medium is reproduced at a transfer rate of 36 Mbps, 40 Mbps or faster.

28. The method of claim 22, wherein the playback speed information is recorded as a ratio of transfer rate of the main data.

29. A recording medium having a data structure, wherein the data structure includes a main data and a control data, the control data is recorded in a specific area of the recording medium, and includes a playback speed information and a maximum transfer rate information specifying the maximum transfer rate needed by an application, wherein the playback speed information is distinguished from the maximum transfer rate information.

30. The recording medium of claim 29, wherein the specific area is lead-in area, the playback speed information and the maximum transfer rate information are recorded within a control information table allocated in the lead-in area on the recording medium.

31. The recording medium of claim 30, wherein the control information table further includes a recording medium size and version information specifying the medium size and version number respectively, a medium structure information specifying the number of recorded layers and the type of the recoded layers, and a recording density information associated with recording density of the recording medium.

32. The recording medium of claim 29, wherein the playback speed information represents 1.2 or 1.5 times of reference speed.

33. The recording medium of claim 29, wherein the playback speed information is recorded such that the main data on the recording medium is reproduced at 1.2 or 1.5 times of reference speed.

34. The recording medium of claim 29, wherein the playback speed information is recorded such that the main data on the recording medium is reproduced at a transfer rate of 36 Mbps, 40 Mbps or faster.

35. The recording medium of claim 29, wherein the playback speed information is recorded as a ratio of transfer rate of the main data.

36. A method of reproducing data from a recording medium, the comprising steps of:
reading a control information from a specific area of the recording medium, the control information including a playback speed information and a maximum transfer rate information specifying the maximum transfer rate needed by an application, wherein the playback speed information is distinguished from the maximum transfer rate information; and
reproducing a main data recorded on a main data area in response to the playback speed information and/or the maximum transfer rate information.

37. The method of claim 36, wherein the specific area is lead-in area, the playback speed information and the maximum transfer rate information are recorded within a control information table allocated in the lead-in area on the recording medium.

38. The method of claim 37, wherein the control information table further includes a recording medium size and version information specifying the medium size and version number respectively, a medium structure information specifying the number of recorded layers and the type of the recoded layers, and a recording density information associated with recording density of the recording medium.

39. The method of claim 36, wherein the reproducing step reproduces the main data in response to the playback speed information representing 1.2 or 1.5 times of reference speed.

40. The method of claim 36, wherein the reproducing step reproduces the main data in response to the playback speed information determined such that the main data is reproduced at 1.2 or 1.5 times of reference speed.

41. The method of claim 36, wherein the reproducing step reproduces the main data in response to the playback speed information determined such that the main data is reproduced at a transfer rate of 36 Mbps, 40 Mbps or faster.

42. The method of claim 36, wherein the reproducing step reproduces the main data in response to the playback speed information recorded as a ratio of transfer rate of the main data.
